(19) United States
(12) Patent Application Publication
(10) Pub. No.: US 2025/0140833 A1
(43) Pub. Date: May 1, 2025

(54) DOPING STRATEGY TO STABILIZE ANION OXIDATION IN LMR CATHODES FOR LI-ION BATTERIES

(71) Applicant: Samsung SDI Co., Ltd., Yongin-si (KR)

(72) Inventors: Valentina Lacivita, Cambridge, MA (US); Yan Wang, Brookline, MA (US); Michael Chon, Medford, MA (US); Qingjie Li, Arlington, MA (US); Yongwoo Shin, Concord, MA (US); Samuel Cross, Cambridge, MA (US); Haemin Paik, Cambridge, MA (US); Jungjoon Kim, Cambridge, MA (US)

(73) Assignee: Samsung SDI Co., Ltd., Yongin-si (KR)

(21) Appl. No.: 18/410,604

(22) Filed: Jan. 11, 2024

Related U.S. Application Data
(60) Provisional application No. 63/546,870, filed on Nov. 1, 2023.

(51) Int. Cl. H01M 4/525; H01M 4/02; H01M 4/04; H01M 4/505; H01M 10/0525

(52) U.S. Cl. CPC H01M 4/525; H01M 4/0459; H01M 4/505; H01M 2004/028; H01M 10/0525

(57) ABSTRACT

Compounds for use in cathodes for Li-ion batteries include Li₂Mn_{0.88}A_{0.06}B_{0.06}O₃, wherein A and B are dopants in one of the following combinations: A=Sr, B═Cr; A=Be, B═Cr; A=Ca, B═Cr; A=Zn, B═Cr; A=Co, B═Cr; A=Co, B═V; A=Fe, B═As; A=Y, B═Sb; A=Rh, B═V; A=Cr, B═V; A=Cr, B═Ta; or A=B═Ce. A high-throughput computational doping procedure for Li₂Mn_{0.88}A_{0.06}B_{0.06}O₃ compounds includes satisfying the following screening criteria: (i) M/O PDOS ratio (where M involves all cation species other than Li) is larger than in pristine Li₂MnO₃; (ii) calculated voltage for Li extraction is close to or even higher than in pristine Li₂MnO₃; (iii) doped compound is thermodynamically stable, with Eₕᵤₗₗ equal or close to 0 eV/atom; (iv) dopants A and B dissolve more favorably in the Li₂MnO₃ phase over the LiMO₂ phase, such that ΔE=Eₕᵤₗₗ(Li₂MnO₃)−Eₕᵤₗₗ(LiMO₂)<0.

### CROSS-REFERENCE TO RELATED APPLICATION

This application is based on and claims priority from U.S. Provisional Application No. 63/546,870 filed on Nov. 1, 2023 in the U.S. Patent and Trademark Office, the disclosure of which is incorporated herein by reference in its entirety.

### BACKGROUND

### 1. Field

Materials according to embodiments relate to compounds for use in cathodes for Li-ion batteries.

### 2. Description of the Related Art

A high capacity cathode is the key to the realization of high-energy-density lithium-ion batteries.

Li— and Mn-rich (LMR) transition metal (TM) oxides are labeled among the most promising candidates for next generation cathode materials for rechargeable Li-ion batteries (LIBs) because of their prominent energy density of ˜1000 Wh kg⁻¹.

LMR cathodes are generally characterized by two domains: one layered LiTMO₂ domain, which delivers capacity via the TM redox, and a Li—Mn-rich domain, Li₂MnO₃, which contributes additional anion capacity from oxygen redox. LMR cathodes may be generally denoted by the following chemical formula: xLi₂MnO₃·(1−x)LiTMO₂ (TM=Mn, Ni, Co). In this regard, it is noted that LiTMO₂ and LiMO₂ are used interchangeably herein.

The anionic oxygen redox induced by activation of the Li₂MnO₃ domain in LMR has previously afforded an O3-type layered Li-rich material used as the cathode for lithium-ion batteries with a notably high capacity of 250-300 mAh g⁻¹.

However, there are problems with some embodiments, as discussed below.

A major challenge for commercialization of lithium- and manganese-rich (LMR) materials is represented by the progressive fading of the discharge voltage over cycling due to phase change and oxygen release at high states of delithiation. See FIG. 1.

In particular, the voltage fading problem in LMR cathodes is related to 3 main causes:
(1) O₂ release and consequent irreversible structure degradation. In this regard, oxygen oxidation (voltage plateau 4.5-4.8V @1st cycle) results in O₂ release.
(2) Phase transition from layered to spinel phase triggered by TM migration into the Li layer at high voltage.
(3) Strain effects during Li extraction. In particular, Li extraction in LMR results in volume changes, which in turn results in strain.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

The disclosure provides materials for use in LMR cathodes for Li-ion batteries, according to embodiments.

Delithiation starts in the layered LiTMO₂ (112) phase, while the Li₂MnO₃ (213) phase is activated afterwards above ˜4.5V. That is, as shown in FIG. 2, delithiation starts in the layered LiMO₂ phase (C1 step) (again, it is noted that LiTMO₂ and LiMO₂ are used interchangeably herein), and Li₂MnO₃ is activated afterwards (C2 step). Density Functional Theory (DFT) calculations indicate that delithiation of the 213 phase leads immediately to O oxidation (C2 charging step). The D1 step is the discharging of the cathode.

Hence, the need arises to stabilize oxygen electronic levels against release of O₂.

The present disclosure introduces a new “descriptor” for estimating oxygen stability in LMR. That is, the ratio between the calculated density of states projected onto TM and O at the top of the valence band, “M/O PDOS”. See FIG. 3 as an example of calculated element projected density of states (PDOS) for pristine and partially delithiated 213 phase. This result is consistent with the literature, as can be seen from FIG. 4.

In pristine Li₂MnO₃, the M/O PDOS ratio is about 0.15. The criterion in the present disclosure to stabilize O against oxidation and consequent release from the 213 structure is to increase such ratio (and therefore the hybridization between metal and oxygen electronic levels) via doping the TM site.

The present disclosure has developed a high-throughput (HT) computational screening workflow based on Density Functional Theory (DFT) calculations. In this way, the present disclosure found dopants that are predicted to increase the “M/O PDOS” ratio compared to pristine Li₂MnO₃, while being stably incorporated in such phase. Thermodynamic stability is evaluated using energies above the convex hull of DFT-calculated phase diagrams (Eₕᵤₗₗ).

The present disclosure is the first time that the calculated “M/O PDOS” ratio is used as a criterion to predict oxygen stability vs. oxidation and O₂ release. Using this criterion, the present disclosure can leverage a HT computational screening workflow and identify new dopants combinations that increase such ratio.

The “M/O PDOS” ratio criterion here adopted allows for HT screening of many dopants combinations and concentrations. Using this descriptor (“M/O PDOS” as a “descriptor” for oxygen stability in LMR for the HT screening in the present disclosure), together with calculated voltages and Eₕᵤₗₗ, the present disclosure is able to identify several new dopants combinations promising for improving overall LMR cathodes performance.

An embodiment of the present disclosure includes a Li₂Mn_{0.88}A_{0.06}B_{0.06}O₃, wherein A and B are dopants in one of the following combinations:
A=Sr, B═Cr;
A=Be, B═Cr;
A=Ca, B═Cr;
A=Zn, B═Cr;
A=Co, B═Cr;
A=Co, B═V;
A=Fe, B═As;
A=Y, B═Sb;
A=Rh, B═V;
A=Cr, B═V;
A=Cr, B═Ta; or
A=B═Ce.

Another embodiment includes a Li₂Mn_{0.88}A_{0.06}B_{0.06}O₃, wherein A and B are dopants in one of the following combinations:
A=Sr, B═Cr;
A=Be, B═Cr;
A=Ca, B═Cr;
A=Zn, B═Cr;
A=Co, B═Cr;
A=Co, B═V;
A=Rh, B═V; or
A=B═Ce.

Another embodiment includes Li₂Mn_{0.88}A_{0.06}B_{0.06}O₃, wherein A=Sr and B═Cr.

Another embodiment includes Li₂Mn_{0.88}A_{0.06}B_{0.06}O₃, wherein A=Be and B═Cr.

Another embodiment includes Li₂Mn_{0.88}A_{0.06}B_{0.06}O₃, wherein A=Ca and B═Cr.

Another embodiment includes Li₂Mn_{0.88}A_{0.06}B_{0.06}O₃, wherein A=Zn and B═Cr.

Another embodiment includes Li₂Mn_{0.88}A_{0.06}B_{0.06}O₃, wherein A=Co and B═Cr.

Another embodiment includes Li₂Mn_{0.88}A_{0.06}B_{0.06}O₃, wherein A=Co and B═V.

Another embodiment includes Li₂Mn_{0.88}A_{0.06}B_{0.06}O₃, wherein A=Fe and B═As.

Another embodiment includes Li₂Mn_{0.88}A_{0.06}B_{0.06}O₃, wherein A=Y and B═Sb.

Another embodiment includes Li₂Mn_{0.88}A_{0.06}B_{0.06}O₃, wherein A=Rh and B═V.

Another embodiment includes Li₂Mn_{0.88}A_{0.06}B_{0.06}O₃, wherein A=Cr and B═V.

Another embodiment includes Li₂Mn_{0.88}A_{0.06}B_{0.06}O₃, wherein A=Cr and B═Ta.

Another embodiment includes Li₂Mn_{0.88}A_{0.06}B_{0.06}O₃, wherein A=B═Ce.

Another embodiment includes a high-throughput computational doping procedure for Li₂Mn_{0.88}A_{0.06}B_{0.06}O₃ compounds which comprises satisfying the following screening criteria:
(i) M/O PDOS ratio (where M involves all cation species other than Li) is larger than in pristine Li₂MnO₃;
(ii) Calculated voltage for Li extraction 4.25 or above;
(iii) Doped compound is thermodynamically stable, with Eₕᵤₗₗ being 0.03 eV/atom or below;
(iv) Dopants A and B dissolve more favorably in the Li₂MnO₃ phase over the LiMO₂ phase, such that ΔE=Eₕᵤₗₗ(Li₂MnO₃)−Eₕᵤₗₗ(LiMO₂)<0.

Another embodiment includes the aforementioned high-throughput computational doping procedure, wherein the calculated voltage for Li extraction is higher than in pristine Li₂MnO₃.

Another embodiment includes the aforementioned high-throughput computational doping procedure, wherein Eₕᵤₗₗ is 0.025 eV/atom or below.

Another embodiment includes the aforementioned high-throughput computational doping procedure, wherein Eₕᵤₗₗ is equal to 0 eV/atom.

Another embodiment includes a cathode comprising Li₂Mn_{0.88}A_{0.06}B_{0.06}O₃ as described above.

Another embodiment includes a rechargeable battery comprising an anode, a cathode, and an electrolyte, wherein the cathode comprises Li₂Mn_{0.88}A_{0.06}B_{0.06}O₃ as described above.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Example embodiments of the present disclosure will be more clearly understood from the following detailed description taken in conjunction with the accompanying drawings in which:

FIG. 1 is a graph showing voltage vs. specific capacity and the voltage fading due to phase transformation during cycling.

FIG. 2 is a graph showing delithiation starting in the layered LiMO₂ phase (C1 step), and Li₂MnO₃ being activated afterwards (C2 step), and then the discharge of the cathode (D1 step), with the figure also showing the changes in lattice parameters and volume during these steps.

FIG. 3 shows graphs illustrating calculated element projected density of states for pristine and partially delithiated Li₂MnO₃.

FIG. 4 shows graphs illustrating calculated density of states for pristine and partially delithiated Li₂MnO₃ as reported in Chem. Mater. 2016, 28, 6656-6663 for purposes of comparison with present calculations.

FIG. 5 shows computed electronic structure changes (PDOS) in Li₂Mn_{0.88}Ca_{0.06}Cr_{0.06}O₃ compared to pristine Li₂MnO₃.

FIG. 6 is a diagram showing an exemplary embodiment of the high-throughput (HT) computational screening workflow.

FIG. 7A shows DFT calculated M-O orbital hybridization and FIG. 7B shows Li extraction voltages, indicating various dopants combinations that could stabilize the oxygen redox, e.g., Cr, Rh, Co, V, Zn, Ca, in various combinations.

FIG. 8 shows the calculated Eₕᵤₗₗ for doped Li₂MnO₃.

FIG. 9 is a heat-map with differences in calculated Eₕᵤₗₗ for doped Li₂MnO₃ (213) and LiNi_{0.75}Mn_{0.25}O₂ (112) phases.

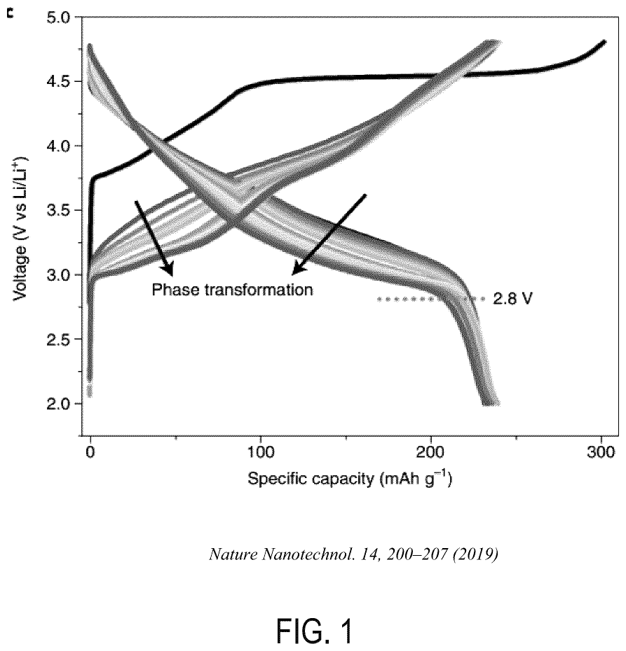

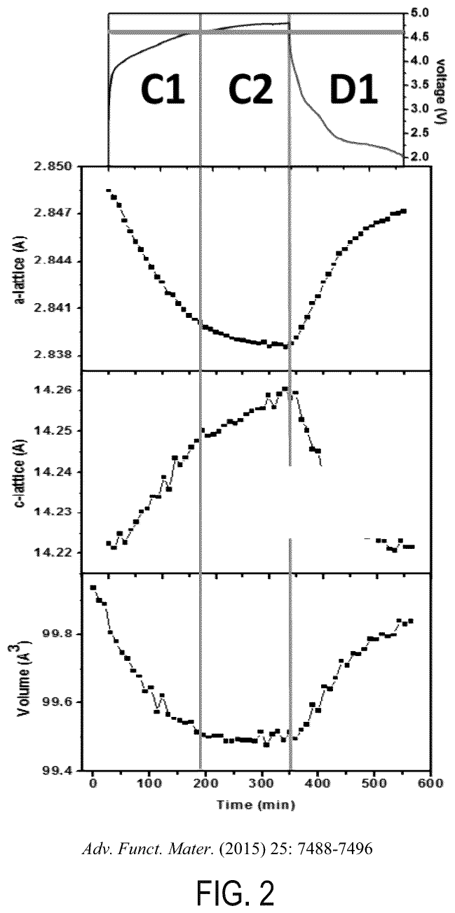

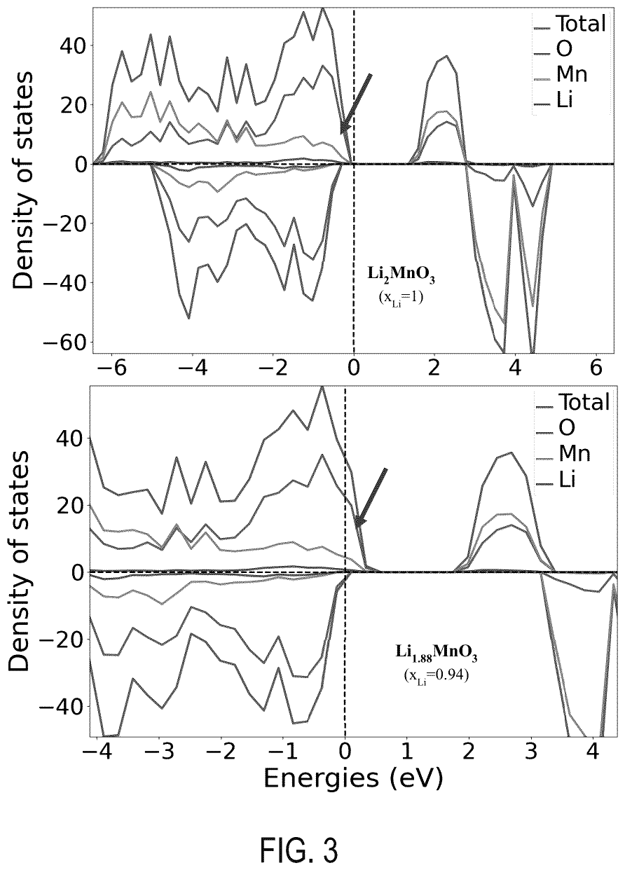

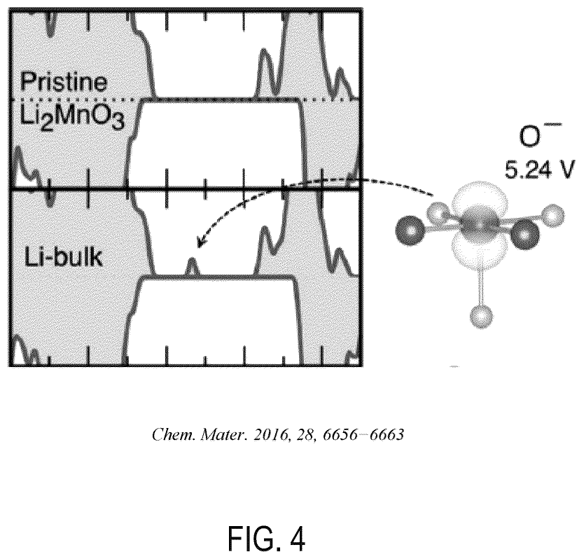

### DETAILED DESCRIPTION OF EXAMPLE EMBODIMENTS

The embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure. For example, even if matters described in a specific example or embodiment are not described in a different example or embodiment thereto, the matters may be understood as being related to or combined with the different example or embodiment, unless otherwise mentioned in descriptions thereof. In addition, it should be understood that all descriptions of principles, aspects, examples, and embodiments of the disclosure are intended to encompass structural and functional equivalents thereof. In addition, these equivalents should be understood as including not only currently well-known equivalents but also equivalents to be developed in the future.

As used herein, expressions such as “at least one of,” when preceding a list of elements, modify the entire list of elements and do not modify the individual elements of the list. For example, the expression, “at least one of a, b and c,” should be understood as including only a, only b, only c, both a and b, both a and c, both b and c, or all of a, b and c.

The present disclosure has devised an efficient HT computational workflow for identifying dopants and combinations thereof that could stabilize LMR cathodes against irreversible O₂ release.

The criteria used in the computational screening procedure of the present disclosure are:
Calculated “M/O PDOS” ratio at the top of the valence band larger than 0.15 (value in pristine Li₂MnO₃)
Thermodynamic stability, namely, low Eₕᵤₗₗ of the doped 213 phase
More favorable solubility in the 213 phase than in the 112 phase, i.e., Eₕᵤₗₗ(213)<Eₕᵤₗₗ(112)
High calculated voltage for delithiation, i.e., close to 4.5V or above (4.25V or above, preferably 4.5V or above, or ˜4.6V)

That is, the present disclosure includes a high-throughput computational doping procedure for Li₂Mn_{0.88}A_{0.06}B_{0.06}O₃ compounds which comprises satisfying the following screening criteria:
(i) M/O PDOS ratio (where M involves all cation species other than Li) should be larger than in pristine Li₂MnO₃;
(ii) Calculated voltage for Li extraction should be close to or even higher than in pristine Li₂MnO₃ (4.25V or above, preferably 4.5V or above, or ˜4.6V);
(iii) Doped compound should be thermodynamically stable, with Eₕᵤₗₗ equal or close to 0 eV/atom (0.03 eV/atom or below, preferably 0.025 eV/atom or below);
(iv) Dopants A and B should dissolve more favorably in the Li₂MnO₃ phase over the LiMO₂ phase, such that ΔE=Eₕᵤₗₗ(Li₂MnO₃)−Eₕᵤₗₗ(LiMO₂)<0 (ΔE is the delta, i.e., the difference between Eₕᵤₗₗ(Li₂MnO₃) and Eₕᵤₗₗ(LiMO₂)).

As a result, the HT computational workflow has identified dopants and combinations thereof that could stabilize LMR cathodes against irreversible O₂ release. Thus, embodiments of the present disclosure can be represented by the general formula Li₂Mn_{0.88}A_{0.06}B_{0.06}O₃, wherein A and B are dopants in one of the following combinations: A=Sr, B═Cr; A=Be, B═Cr; A=Ca, B═Cr; A=Zn, B═Cr; A=Co, B═Cr; A=Co, B═V; A=Fe, B═As; A=Y, B═Sb; A=Rh, B═V; A=Cr, B═V; A=Cr, B═Ta; or A=B═Ce. For example, the combination could be A=Cr, B═V.

Embodiments of the present disclosure can be made using a standard solid-state method. In this method, precursor powders are combined in a certain ratio depending on the composition of the target material. In a typical preparation, precursors may consist of lithium carbonate, manganese oxide, and at least one precursor containing each of the included metals from A and B. Examples of metal precursors include metal oxides, hydroxides, carbonates, and nitrates.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature for an appropriate period of time to produce an oxide powder with the desired composition and crystal structure.

Subsequently the oxide powder may be compressed using a hydraulic uniaxial press to form a densely packed pellet. Heat treatment may then be applied at an appropriate temperature for an appropriate period of time to produce a dense pellet which may be used as a cathode in a lithium-ion battery cell.

An embodiment of the aforementioned cathode active material layer can be assembled together with an electrolyte and an anode active material layer to be used in an embodiment which is a rechargeable battery comprising a cathode active material layer, an anode active material layer, and an electrolyte between the cathode active material layer and the anode active material layer, wherein the cathode active material layer comprises any of the aforementioned materials. For example, an embodiment of the aforementioned cathode active material layer can be assembled together with a solid electrolyte separator and an anode active material layer to be used in an embodiment which is a solid state lithium battery comprising a cathode active material layer, an anode active material layer, and a solid electrolyte layer formed between the cathode active material layer and the anode active material layer, wherein the cathode active material layer comprises any of the aforementioned materials. As another example, an embodiment of the aforementioned cathode active material layer can be assembled together with a liquid electrolyte, a separator, and an anode active material layer to be used in an embodiment which is a lithium-ion battery comprising a cathode active material layer, an anode active material layer, and a liquid electrolyte with a separator formed between the cathode active material layer and the anode active material layer, wherein the cathode active material layer comprises any of the aforementioned materials.

### EXAMPLES

Embodiments will now be illustrated by way of the following examples, which do not limit the embodiments in any way.

“M/O PDOS” ratios are obtained by integration of the element-projected density of states (PDOS) at the top of the valence band. “M/O PDOS” acts as a “descriptor” for oxygen stability in LMR for the HT screening in the present disclosure.

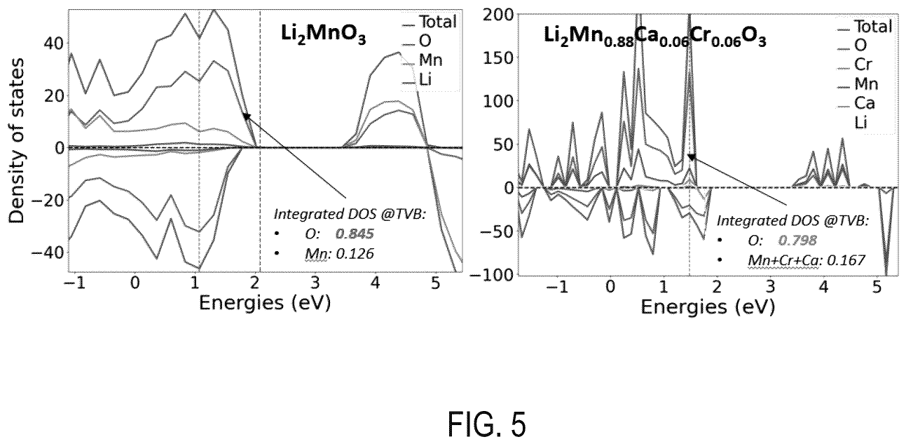

For example, FIG. 5 shows the result of Ca+Cr doping in the 213 phase. Compared to the pristine 213 phase on the left in FIG. 5, the Ca+Cr doped one on the right in FIG. 5 shows an increase of the M/O PDOS ratio to ˜0.2 which indicates a higher level of hybridization (or overlap) between oxygen and metal electronic states. That is, Cr+Ca doping is found to increase the M/O PDOS ratio from ˜0.15 to ˜0.2. Such larger hybridization is expected to stabilize the oxygen when oxidized upon delithiation of Li₂MnO₃.

In particular, in FIG. 5, the integrated DOS @TVB (top of valence band) with dopant (e.g., Ca+Cr) shows reduced oxygen contribution to the electronic density of states, namely, larger hybridization with the metal electronic levels, which results in oxygen being stabilized when oxidized upon delithiation.

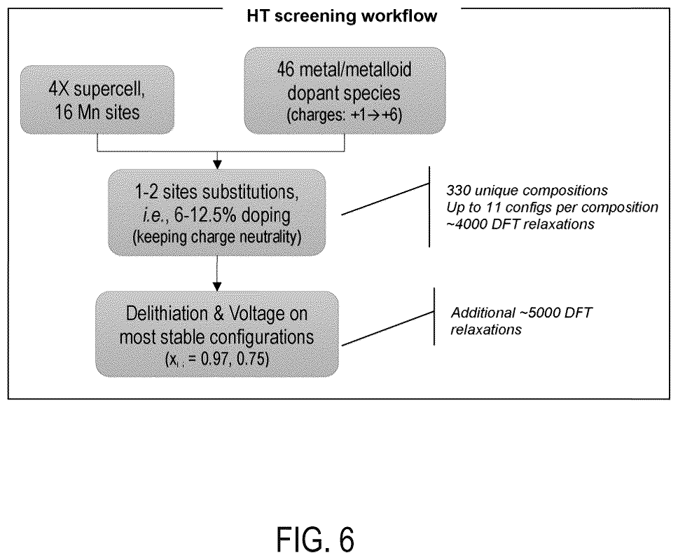

The present disclosure has developed and implemented a computational workflow as shown in FIG. 6 to dope parent Li₂MnO₃ structure with redox active elements (multiple oxidation states possible), ensure charge balance and generate ordered configurations.

The present disclosure has performed Density Functional Theory (DFT) calculations for doped Li_{2-z}M_{1-x-y}AₓO_{y}O₃ A and B are selected 1⁺, 2⁺, 3⁺, 4⁺, 5⁺, and 6⁺ dopants from a list of elements as shown in Table 1 below.

TABLE 1
Dopants and related oxidation states

| | M | 1 | 2 | 3 | 4 | 5 | 6 |
|---|---|---|---|---|---|---|---|
| 0 | Be | — | 2.0 | — | — | — | — |
| 1 | Na | 1.0 | — | — | — | — | — |
| 2 | Mg | — | 2.0 | — | — | — | — |
| 3 | Al | — | — | 3.0 | — | — | — |
| 4 | K | 1.0 | — | — | — | — | — |
| 5 | Ca | — | 2.0 | — | — | — | — |
| 6 | Sc | — | — | 3.0 | — | — | — |
| 7 | Ti | — | — | — | 4.0 | — | — |
| 8 | V | — | — | — | — | 5.0 | — |
| 9 | Cr | — | — | 3.0 | — | — | 6.0 |
| 10 | Fe | — | 2.0 | 3.0 | — | — | — |
| 11 | Co | — | 2.0 | 3.0 | — | — | — |
| 12 | Ni | — | 2.0 | — | — | — | — |
| 13 | Cu | — | 2.0 | — | — | — | — |
| 14 | Zn | — | 2.0 | — | — | — | — |
| 15 | Ga | — | — | 3.0 | — | — | — |
| 16 | Rb | 1.0 | — | — | — | — | — |
| 17 | Sr | — | 2.0 | — | — | — | — |
| 18 | Y | — | — | 3.0 | — | — | — |
| 19 | Zr | — | — | — | 4.0 | — | — |
| 20 | Nb | — | — | — | — | 5.0 | — |
| 21 | Mo | — | — | — | 4.0 | — | 6.0 |
| 22 | Ru | — | — | 3.0 | 4.0 | — | — |
| 23 | Rh | — | — | 3.0 | — | — | — |
| 24 | Ag | 1.0 | — | — | — | — | — |
| 25 | Cd | — | 2.0 | — | — | — | — |
| 26 | In | — | — | 3.0 | — | — | — |
| 27 | Sn | — | 2.0 | — | 4.0 | — | — |
| 28 | Cs | 1.0 | — | — | — | — | — |
| 29 | Ba | — | 2.0 | — | — | — | — |
| 30 | La | — | — | 3.0 | — | — | — |
| 31 | Ce | — | — | 3.0 | 4.0 | — | — |
| 32 | Pr | — | — | 3.0 | — | — | — |
| 33 | Nd | — | — | 3.0 | — | — | — |
| 34 | Hf | — | — | — | 4.0 | — | — |
| 35 | Ta | — | — | — | — | 5.0 | — |
| 36 | W | — | — | — | 4.0 | — | 6.0 |
| 37 | Tl | 1.0 | — | 3.0 | — | — | — |
| 38 | Pb | — | 2.0 | — | 4.0 | — | — |
| 39 | Bi | — | — | 3.0 | — | — | — |
| 40 | B | — | — | 3.0 | — | — | — |
| 41 | Si | — | — | — | 4.0 | — | — |
| 42 | Ge | — | 2.0 | — | 4.0 | — | — |
| 43 | As | — | — | 3.0 | — | 5.0 | — |
| 44 | Sb | — | — | 3.0 | — | 5.0 | — |
| 45 | Te | — | 2.0 | — | 4.0 | — | 6.0 |

The goals were (A) to find dopants with good solubility in Li₂MnO₃ phase; and (B) to find dopants that can stabilize O electronic levels at the top of the valence band (TVB) preventing complete anion oxidation and O₂ release.

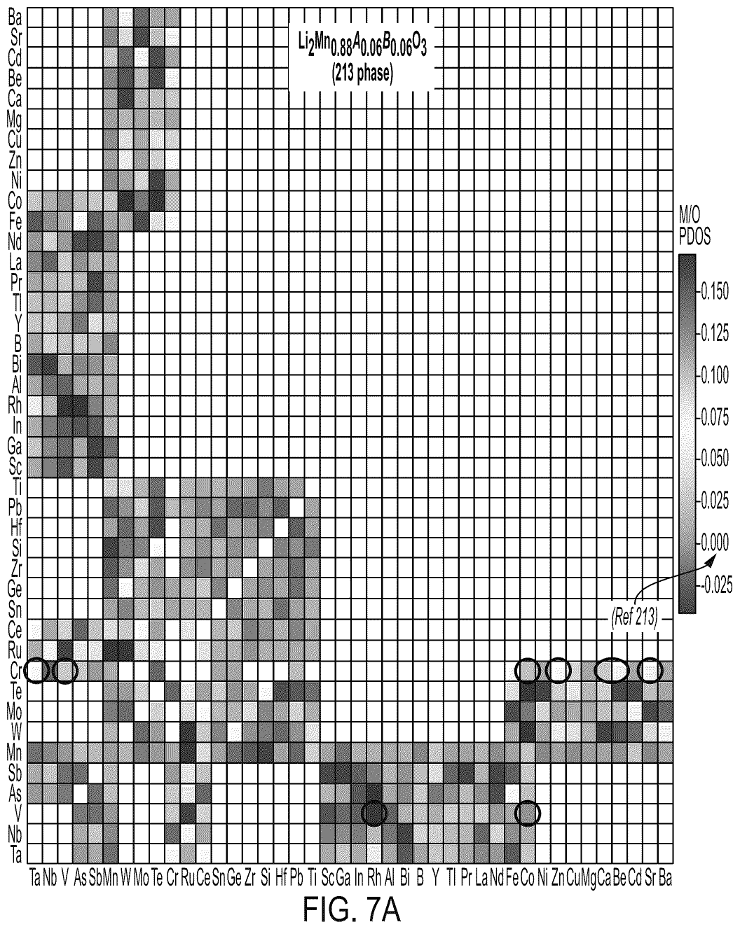

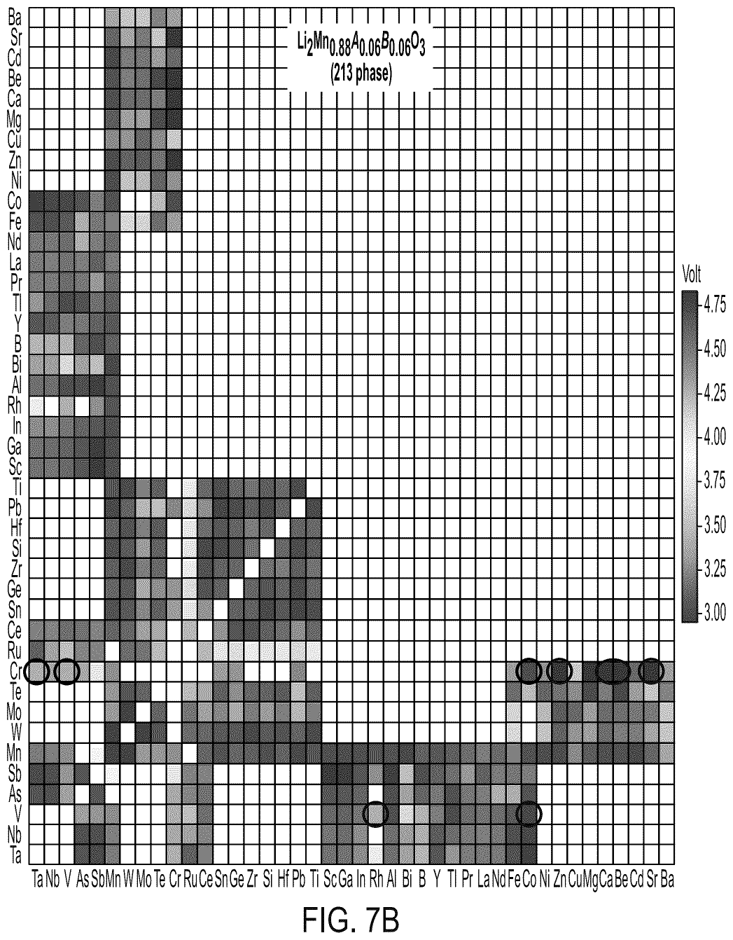

Summaries of the results of exemplary embodiments are depicted in FIGS. 7A, 7B, 8, and 9.

In particular, heat-maps of calculated M/O PDOS (DFT calculated M-O orbital hybridization) are shown in FIG. 7A and Li extraction voltages are shown in FIG. 7B with different dopants combinations that could stabilize the oxygen redox, e.g., Cr, Rh, Co, V, Zn, Ca, in various combinations. Values are Boltzmann averages (at 300K) over all configurations calculated for each combination of dopants, and at the Li content corresponding to the maximum voltage obtained for such dopants combination. Examples of promising dopants combinations are highlighted with circles.

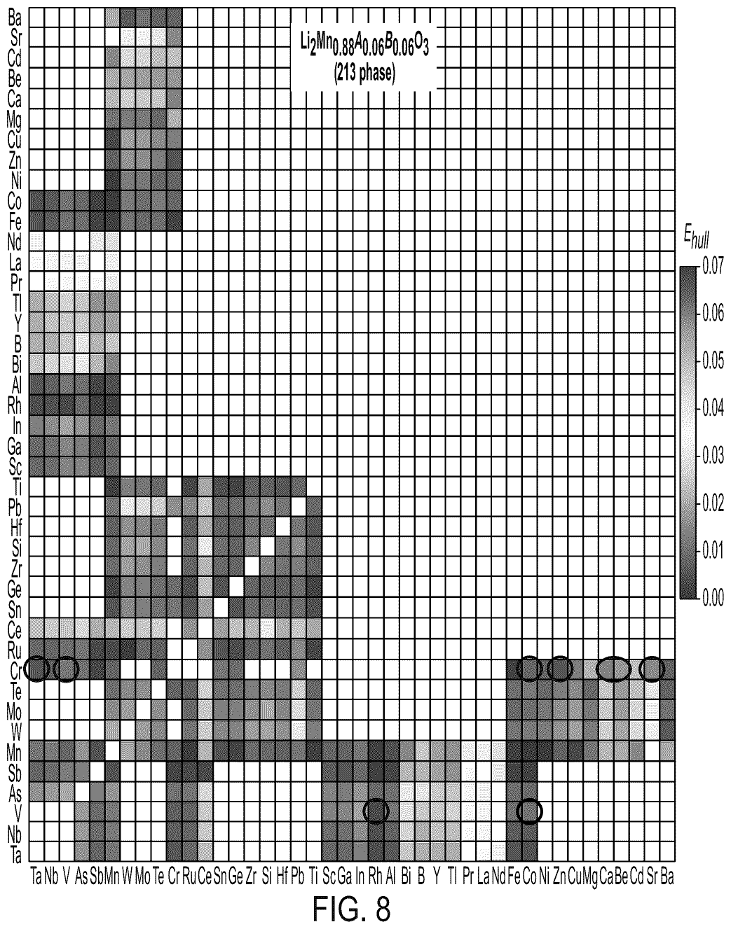

FIG. 8 shows the calculated Eₕᵤₗₗ for doped Li₂MnO₃. The predicted dopant solubility is generally good and agrees relatively well with experimental observations (see Table 2 below).

TABLE 2

| | DFT Eₕᵤₗₗ | Dopant solubility | Impurities |
|---|---|---|---|
| Dopant | (meV/at) | (experiments) | (experiments) |
| Mg | 11 | Some | |
| Al | 5 | Good | |
| Si | 6 | Some | |
| Ca | 22 | Some | |
| Sc | 8 | Good | |
| Ti | 1 | Good | |
| Cr | 5 | Good | |
| Fe | 1 | Good | |
| Co | 1 | Good | |
| Ni | 1 | Good | |
| Cu | 3 | Some | |
| Zn | 7 | Some | |
| Ga | 8 | Some | |
| Sr | 34 | Poor | |
| Y | 19 | Poor | YMnO₃ (62), YMn₂O₅ (55) |
| Zr | 12 | Poor | |
| Nb | 12 | Poor | LiNbO₃ (161) |
| In | 11 | Poor | In₂O₃ (199) |
| Sn | 4 | Poor | SnO₂ (136) |
| Te | 9 | Some | |
| Ba | 54 | Poor | BaMnO₃ (194) |
| La | 31 | Poor | LaMnO₃ (14) |
| Nd | 28 | Poor | NdMnO₃ (14) |
| Hf | 5 | Poor | HfO₂ (14) |
| Ta | 11 | Poor | LiTaO₃ (161) |

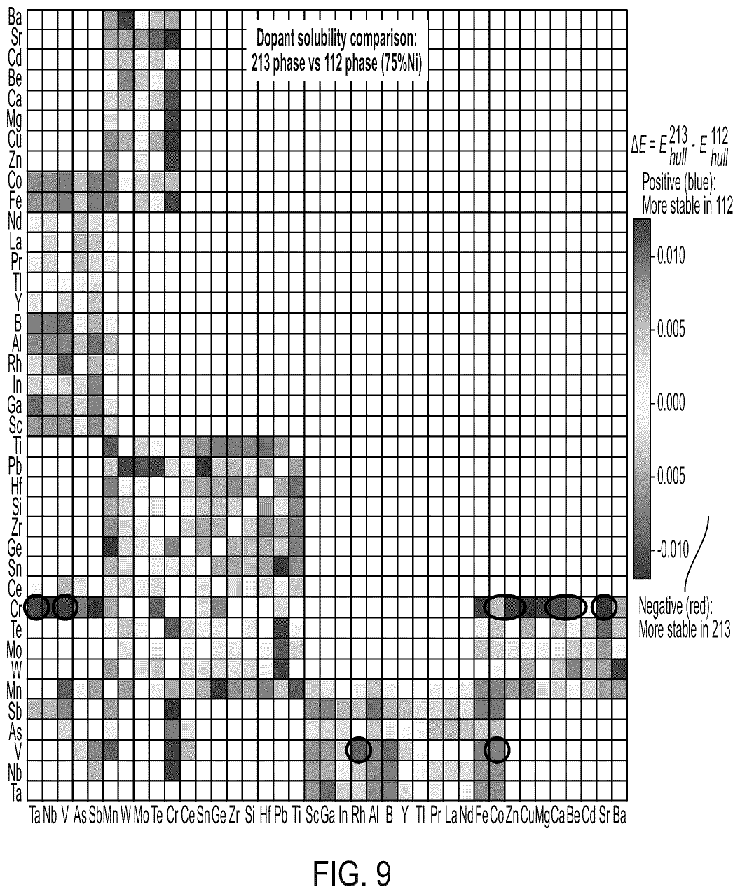

FIG. 9 shows a heat-map with differences in calculated Eₕᵤₗₗ for doped Li₂MnO₃ (213) and LiNi_{0.75}Mn_{0.25}O₂ (112) phases. Energy-above-hull is used as a “descriptor” for dopant/substitution element stability in LMR. Negative ΔE values indicate dopants with higher solubility in 213 phase. HT calculations identify dopants with higher solubility for Li₂MnO₃ 213 phase, e.g., Cr, Co, V, Zn, Ca, in various combinations.

Based on the results of the HT computational screening, the present disclosure has identified several dopants combinations that can stabilize the O redox in the Li—Mn-rich domains of LMR cathodes.

These can be represented by the general formula Li₂Mn_{0.88}A_{0.06}B_{0.06}O₃, where A and B are dopants in one of the following combinations:
A=Sr, B═Cr
A=Be, B═Cr
A=Ca, B═Cr
A=Zn, B═Cr
A=Co, B═Cr
A=Co, B═V
A=Fe, B═As
A=Y, B═Sb
A=Rh, B═V
A=Cr, B═V
A=Cr, B═Ta
A=B═Ce

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. Li₂Mn_{0.88}A_{0.06}B_{0.06}O₃, wherein A and B are dopants in one of the following combinations:
A=Sr, B═Cr;
A=Be, B═Cr;
A=Ca, B═Cr;
A=Zn, B═Cr;
A=Co, B═Cr;
A=Co, B═V;
A=Fe, B═As;
A=Y, B═Sb;
A=Rh, B═V;
A=Cr, B═V;
A=Cr, B═Ta;
A=B═Ce.

2. Li₂Mn_{0.88}A_{0.06}B_{0.06}O₃ according to claim 1, wherein A and B are dopants in one of the following combinations:
A=Sr, B═Cr;
A=Be, B═Cr;
A=Ca, B═Cr;
A=Zn, B═Cr;
A=Co, B═Cr;
A=Co, B═V;
A=Rh, B═V;
A=B═Ce.

3. Li₂Mn_{0.88}A_{0.06}B_{0.06}O₃ according to claim 1, wherein A=Sr and B═Cr.

4. Li₂Mn_{0.88}A_{0.06}B_{0.06}O₃ according to claim 1, wherein A=Be and B═Cr.

5. Li₂Mn_{0.88}A_{0.06}B_{0.06}O₃ according to claim 1, wherein A=Ca and B═Cr.

6. Li₂Mn_{0.88}A_{0.06}B_{0.06}O₃ according to claim 1, wherein A=Zn and B═Cr.

7. Li₂Mn_{0.88}A_{0.06}B_{0.06}O₃ according to claim 1, wherein A=Co and B═Cr.

8. Li₂Mn_{0.88}A_{0.06}B_{0.06}O₃ according to claim 1, wherein A=Co and B═V.

9. Li₂Mn_{0.88}A_{0.06}B_{0.06}O₃ according to claim 1, wherein A=Fe and B═As.

10. Li₂Mn_{0.88}A_{0.06}B_{0.06}O₃ according to claim 1, wherein A=Y and B═Sb.

11. Li₂Mn_{0.88}A_{0.06}B_{0.06}O₃ according to claim 1, wherein A=Rh and B═V.

12. Li₂Mn_{0.88}A_{0.06}B_{0.06}O₃ according to claim 1, wherein A=Cr and B═V.

13. Li₂Mn_{0.88}A_{0.06}B_{0.06}O₃ according to claim 1, wherein A=Cr and B═Ta.

14. Li₂Mn_{0.88}A_{0.06}B_{0.06}O₃ according to claim 1, wherein A=B═Ce.

15. A high-throughput computational doping procedure for Li₂Mn_{0.88}A_{0.06}B_{0.06}O₃ compounds which comprises satisfying the following screening criteria:
(i) M/O PDOS ratio, where M involves all cation species other than Li, is larger than in pristine Li₂MnO₃;
(ii) Calculated voltage for Li extraction is 4.25V or above;
(iii) Doped compound is thermodynamically stable, with Eₕᵤₗₗ being 0.03 eV/atom or below;
(iv) Dopants A and B dissolve more favorably in the Li₂MnO₃ phase over the LiMO₂ phase, such that ΔE=Eₕᵤₗₗ(Li₂MnO₃)−Eₕᵤₗₗ(LiMO₂)<0.

16. The high-throughput computational doping procedure according to claim 15, wherein the calculated voltage for Li extraction is higher than in pristine Li₂MnO₃.

17. The high-throughput computational doping procedure according to claim 15, wherein Eₕᵤₗₗ is 0.025 eV/atom or below.

18. The high-throughput computational doping procedure according to claim 15, wherein Eₕᵤₗₗ is equal to 0 eV/atom.

19. A cathode comprising Li₂Mn_{0.88}A_{0.06}B_{0.06}O₃ according to claim 1.

20. A rechargeable battery comprising an anode, a cathode, and an electrolyte, wherein the cathode comprises Li₂Mn_{0.88}A_{0.06}B_{0.06}O₃ according to claim 1.
